(19) United States
(12) Patent Application Publication
(10) Pub. No.: US 2023/0043027 A1
(43) Pub. Date: Feb. 9, 2023

(54) METHODS OF MINIMIZING MICROBIAL RESISTANCE IN DOMESTICATED ANIMALS BY INCORPORATING SUSTAINABLE CARBON PRODUCT SUPPLEMENTS INTO ANIMAL FEED

(71) Applicant: John Murray Minnema, Visalia, CA (US)

(72) Inventor: John Murray Minnema, Visalia, CA (US)

(21) Appl. No.: 17/813,416

(22) Filed: Jul. 19, 2022

Related U.S. Application Data
(60) Provisional application No. 63/203,387, filed on Jul. 20, 2021.

(51) Int. Cl. A23K 20/20; A23K 10/37; A23K 50/75

(52) U.S. Cl. CPC A23K 20/20; A23K 10/37; A23K 50/75

(57) ABSTRACT

The embodiments herein are directed to methods for incorporating high quality, sustainable carbon product into animal feed. In particular, the sustainable carbon product described herein for use in animal feed may be produced as byproducts of efficient, clean energy processes. Utilization of sustainable carbon product produced by such clean energy solutions can provide long-term benefits to the environment, while providing a high-quality feed supplement for treating microbial infections without increasing anti-microbial resistance.

INCORPORATION BY REFERENCE TO ANY PRIORITY APPLICATIONS

This application claims the benefit of U.S. Provisional Application No. 63/203,387, filed Jul. 20, 2021, and titled METHODS OF MINIMIZING MICROBIAL RESISTANCE IN DOMESTICATED ANIMALS BY INCORPORATING SUSTAINABLE CARBON PRODUCT SUPPLEMENTS INTO ANIMAL FEED. Each of the foregoing applications is hereby incorporated by reference in their entirety.

Any and all applications for which a foreign or domestic priority claim is identified in the Application Data Sheet as filed with the present application are hereby incorporated by reference under 37 CFR 1.57.

### BACKGROUND

### Field

The present disclosure relates to animal feeds, and particularly, methods of incorporating carbon into animal feeds.

### Description

Antimicrobial resistance is an emerging problem in veterinary medicine as a consequence of the intensive use and misuse of antimicrobial drugs in livestock and other domesticated animals. Antibiotic resistance happens when bacteria develop the ability to survive or grow despite being exposed to antibiotics designed to kill them. Animals, like people, carry bacteria in their organs. Some of these bacteria may be antibiotic resistant. Antibiotic-resistant bacteria can get in food in several ways, including when animals are slaughtered and processed for food, resistant bacteria can contaminate meat or other animal products. Furthermore, animal waste can contain resistant bacteria and get into the surrounding environment. Antimicrobial use in animals can also contribute to the emergence of antimicrobial resistance in bacteria that may be transferred to humans, thereby reducing the effectiveness of antimicrobial drugs for treating human disease. Thus, novel methods for treating animals with microbial infections without using antimicrobial drugs are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to methods of preventing or treating microbial infection in an animal by incorporating sustainable carbon product into an animal feed, the method comprising: obtaining the sustainable carbon product from a process comprising: obtaining a biomass feedstock; feeding the biomass feedstock to a gasification or pyrolysis system; and gasifying or pyrolyzing the biomass feedstock in the gasification or pyrolysis system to produce a gas and the sustainable carbon product; and incorporating a predetermined amount of the sustainable carbon product per day per animal into an animal feed of an animal subject in need thereof.

In some embodiments, the incorporating the predetermined amount of the sustainable carbon product per day per animal into the animal feed results in at least a 90% reduction in microbe forming the microbial infection. In some embodiments, the incorporating the predetermined amount of the sustainable carbon product per day per animal into the animal feed results in at least a 99% reduction in microbe forming the microbial infection. In some embodiments, the incorporating the predetermined amount of the sustainable carbon product per day per animal into the animal feed results in at least a 99.9% reduction in microbe forming the microbial infection. In some embodiments, the microbe comprises E. coli, Salmonella, aflatoxin, Campylobacter, or mycotoxin.

In some embodiments, the sustainable carbon product comprises particles having a size range of less than 325 mesh. In some embodiments, the biomass comprises agriculture crop residues, forest residues, special crops grown specifically for energy use, organic municipal solid waste, or animal waste. In some embodiments, the biomass comprises pine wood, almond shells and hulls, pistachio shells, walnut shells, or a mixture of two or more of the above.

In some embodiments, the sustainable carbon product comprises at least 85% carbon. In some embodiments, the sustainable carbon product comprises hydrogen, nitrogen, sulfur, or oxygen. In some embodiments, the sustainable carbon product comprises less than 10% ash. In some embodiments, the sustainable carbon product comprises less than 10% water. In some embodiments, the sustainable carbon product comprises substantially no heavy metals or pesticides. In some embodiments, the moisture content of the sustainable carbon product is less than 5%.

In some embodiments, the sustainable carbon product has a bulk density of about 0.42 g/cm3 uncompacted. In some embodiments, the sustainable carbon product has a pH ranging from 6 to 10. In some embodiments, the sustainable carbon product has a melting point of about 3500° C.

In some embodiments, the process comprises a chemical reaction comprising: C₆H₁₂O₆+O₂+H₂O→CO +CO₂+H₂+sustainable carbon product. In some embodiments, the method further comprises incorporating a predetermined amount of montmorillonite clay, a mixture of sustainable carbon product and montmorillonite clay, or neomycin per day per animal into the animal feed. In some embodiments, the process comprises a carbon neutral or minimally carbon negative process. In some embodiments, the sustainable carbon product binds with at least one of ammonia or hydrogen gas in an intestinal tract of the animal.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a flowchart of an exemplary method for supplementing animal feedstock using a sustainable carbon product as described herein.

FIG. 2 illustrates a table of various properties of an example sustainable carbon product according to some embodiments herein.

FIG. 3 illustrates a table of compositional and physical properties of an example sustainable carbon product according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Any time antibiotics are used, in people or animals, they can contribute to the development of antibiotic resistance. Antibiotic use in food animals can help treat microbial diseases in animals. However, to slow the spread of antibiotic resistance, new alternative methods of treating animals with microbial infections without using antimicrobial drugs are needed.

According to the embodiments herein, a sustainable carbon product may be used as an antimicrobial feed supplement in domesticated animals. The embodiments herein are directed to methods for routinely incorporating high quality, sustainable carbon product into animal feed. In particular, the sustainable carbon product described herein for use in animal feed may be produced as byproducts of efficient, clean energy processes. Utilization of sustainable carbon product produced by such clean energy solutions can provide long-term benefits to the environment, while providing a high-quality feed supplement for treating microbial infection of animals.

Sustainable carbon product is a carbonaceous material comprised almost exclusively of pure carbon. Size of particles range from pellets to fine particles. Sustainable carbon product is produced from a variety of feedstock including, for example, pine wood, almond shells and hulls, pistachio shells, walnut shells. The feedstock may be a mixture of different biomass materials. Sustainable carbon product is made through a pyrolysis/gasification production process. Sustainable carbon product may contain over 85% carbon but also hydrogen, nitrogen, sulfur, and oxygen. Sustainable carbon product may also comprise less than 10% ash and less than 10% water. As used herein, Sustainable carbon product may comprise a very low amount or no heavy metals or pesticides.

In some embodiments, sustainable carbon product is a type of charcoal made suitable for agricultural applications. Size of sustainable carbon product particles range from pellets to fine powder of less than 325 mesh. In some embodiments, the moisture content of the sustainable carbon product may be less than 5%. In some embodiments, the sustainable carbon product may have a bulk density around 0.42 g/cm³ uncompacted. Sustainable carbon product is generally not soluble in water and has a pH ranging from around 6 to around 10. Sustainable carbon product may have a melting point around 3500° C. and is stable under normal environmental conditions. Sustainable carbon product is generally incompatible with chlorine, acids, ozone, and liquid oxygen. Sustainable carbon product is generally not toxic to humans or animals.

In some embodiments, the sustainable carbon product feed supplements described herein may be produced as a byproduct of electricity generation. For example, commercially available equipment can convert biomass (e.g., agricultural waste) to electricity and are capable of producing sustainable carbon product as a byproduct.

The environmental and contaminating effects of sustainable carbon product use as described herein may be minimal. The sustainable carbon product is a byproduct of a carbon neutral or minimally carbon negative process. For example, gasification using biomass may be used to produce sustainable carbon product and is desirable from the point of view of decreasing greenhouse emissions, as biomass use is essentially a carbon neutral process if all the biomass is used and can be a carbon negative process if some carbon is sequestered. Due to its portability and widespread availability, biomass is used extensively in small-scale gasification systems.

Furthermore, once consumed by animals, the sustainable carbon product may interact to adsorb and neutralize other toxic materials. Any detrimental interaction with other materials would result from the concentration of these substances in the feces of treated animals. Proper manure management and composting should be able minimize any detrimental interaction.

Some embodiments herein are directed to methods for routinely incorporating high quality, sustainable carbon product into animal feed. In particular, the sustainable carbon product described herein for use in animal feed may be produced as byproducts of efficient, clean energy processes. Utilization of sustainable carbon product produced by such clean energy solutions can provide long-term benefits to the environment, while providing a high-quality feed supplement for detoxification of animals. As used herein, animals refer to any organisms that form the biological kingdom Animalia. Although the embodiments herein are generally described with respect to cattle or other domesticated animals, the embodiments are not limited as such.

As used herein for the purpose of incorporation into animal feed, sustainable carbon product comprises a carbon-based material made of substantially pure carbon. As used herein, sustainable carbon product may be produced from softwood, hardwood, nutshells, coconut shells, hemp, or a combination of a variety of substrates, including those listed above. In some embodiments, sustainable carbon product may comprise over 70% carbonized biomass, less than 10% ash, and less than 12% water (H₂O).

In some embodiments, sustainable carbon product comprises a carbon product suitable as a feed additive for animals. In some embodiments, sustainable carbon product may be formed in size ranges such as to form pellets, shells, rough ground (e.g., >70 microns) powder, to fine ground (40 microns or less) powder. In some embodiments, sustainable carbon product may comprise a moisture content of less than 10%. The bulk density of sustainable carbon product may vary from around 0.01 g/cm to about 10 g/cm. For example, the bulk density of sustainable carbon product used in the methods herein may be about 0 g/cm, about 0.5 g/cm, about 1 g/cm, about 1.5 g/cm, about 2 g/cm, about 2.5 g/cm, about 3 g/cm, about 3.5 g/cm, about 4 g/cm, about 4.5 g/cm, about 5 g/cm, about 5.5 g/cm, about 6 g/cm, about 6.5 g/cm, about 7 g/cm, about 7.5 g/cm, about 8 g/cm, about 8.5 g/cm, about 9 g/cm, about 9.5 g/cm, about 10 g/cm, or any value between the aforementioned values. In some embodiments, the bulk density of sustainable carbon product may be about 0.42 g/cm. In some embodiments, sustainable carbon product may be water insoluble and have a pH between about 6 and about 10. In some embodiments, the melting point of sustainable carbon product may be about 3,500° C.

In some embodiments, sustainable carbon product may comprise a surface area of about 250 m²/g. In some embodiments, sustainable carbon product may comprise a surface area between about 1 m²/g to about 1000 m²/g. For example, in some embodiments, sustainable carbon product may comprise a surface area of about 1 m²/g, about 50 m²/g, about 100 m²/g, about 150 m²/g, about 200 m²/g, about 250 m²/g, about 300 m²/g, about 350 m²/g, about 400 m²/g, about 450 m²/g, about 500 m²/g, about 550 m²/g, about 600 m²/g, about 650 m²/g, about 700 m²/g, about 750 m²/g, about 800 m²/g, about 850 m²/g, about 900 m²/g, about 950 m²/g, about 1000 m²/g, or any value between the aforementioned values.

In some embodiments, the sustainable carbon product feed supplements described herein may be produced as a byproduct of electricity generation. For example, commercially available equipment can convert biomass (e.g., agricultural waste) to electricity and are capable of producing sustainable carbon product as a byproduct, while decreasing or mitigating methane or other greenhouse gas emission.

The environmental and contaminating effects of sustainable carbon product use as described herein may be minimal. The sustainable carbon product may be a byproduct of a carbon neutral or minimally carbon negative process. For example, gasification using biomass may be used to produce sustainable carbon product and is desirable from the point of view of decreasing greenhouse emissions, as biomass use is essentially a carbon neutral process if all the biomass is used and can be a minimally carbon negative process if some carbon is sequestered. Due to its portability and widespread availability, biomass is used extensively in small-scale gasification systems.

Furthermore, once consumed by animals, the sustainable carbon product may interact to adsorb and neutralize other toxic materials. Any detrimental interaction with other materials would result from the concentration of these substances in the feces of treated animals. Proper manure management and composting should be able to mitigate or eliminate the detrimental chemical interactions resulting from treatment. Furthermore, once consumed by animals, the sustainable carbon product may result in a decrease in methane production in vitro. In some embodiments, the sustainable carbon product may be supplemented with electrolytes or other supplements when used in animal feedstock.

In some embodiments, the addition of sustainable carbon product in the amount of about 3 kg per ton of animal feed improves the performance of animals (e.g., chickens), including an approximately 3.5% increase in body weight. In some embodiments, addition of sustainable carbon product to animal feed increases body weight and results in better feed conversion.

In some embodiments, inclusion of sustainable carbon product in animal feed increases adsorption of Campylobacter bacteria, therefore decreasing shed of the bacteria, which is the most common form of food poisoning in raw or undercooked poultry. Campylobacter infection, or campylobacteriosis, is caused by Campylobacter bacteria. It is the most common bacterial cause of diarrheal illness in the United States. Campylobacter is a commensal organism that establishes persistent and benign infections with colonization levels up to 1010 colony-forming units (CFU) per gram of feces in broilers. Campylobacter is highly prevalent in commercial poultry and in chickens raised on organic or free-range farms, indicating that different production systems are equally vulnerable to invasion by this organism. Colonization of poultry by Campylobacter occurs primarily in the lower intestinal tract (cecum, colon, and cloaca). However, the organism can also be recovered to a lesser extent from the small intestines and gizzard, and infrequently from the liver, spleen, and gall bladder. In some embodiments, sustainable carbon product combines pathogen-inactivation and anti-inflammatory effects with lacking antibiotic activities. In some embodiments, these effects minimize the risk of both, resistance development by Campylobacter and intestinal dysbiosis.

In some embodiments, inclusion of sustainable carbon product in animal feed decreases ammonia emissions due to the adsorptive capacity of carbon. In some embodiments, sustainable carbon product acts curatively on the gastrointestinal tract, adsorbing gases such as hydrogen and ammonia that are formed there, bacterial toxins as well as mycotoxins produced by fungi.

In some embodiments, inclusion of sustainable carbon product in animal feed increases adsorption of aflatoxin from contaminated feed, a common widespread problem in the poultry industry. Aflatoxins are a family of toxins produced by certain fungi that are found on agricultural crops such as maize (corn), peanuts, cottonseed, and tree nuts. The main fungi that produce aflatoxins are Aspergillus flavus and Aspergillus parasiticus. Aflatoxin-producing fungi can contaminate crops in the field, at harvest, and during storage, which may then be used in animal feed. Sustainable carbon product may adsorb aflatoxin in a feedstock or in the intestinal tract of an animal an efficient manner.

### Gasification Process for Producing Sustainable Carbon Product

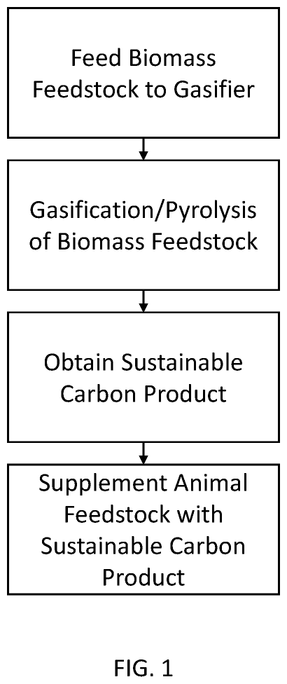

In some embodiments, sustainable carbon product may be obtained as a byproduct of a biomass gasification process. FIG. 1 illustrates a flowchart of an exemplary method for supplementing animal feedstock using a sustainable carbon product as described herein.

As used herein, biomass refers to a renewable organic resource, including, for example, agriculture crop residues (e.g., corn stover or wheat straw), forest residues, special crops grown specifically for energy use (e.g., switch grass or willow trees), organic municipal solid waste, and animal wastes. This renewable resource can be used to produce hydrogen, along with other byproducts, by gasification. Biomass is an ideal feedstock for energy generation processes as there is more biomass available than is required for food and animal feed needs. Furthermore, plants consume carbon dioxide from the atmosphere as part of their natural growth process as they make biomass, offsetting the carbon dioxide released from producing hydrogen through biomass gasification and resulting in low net greenhouse gas emissions.

Pyrolysis, gasification and plasma technologies are thermal processes that use high temperatures to break down waste. The main difference between the above processes and incineration is that they use less oxygen than traditional incineration. The above processes are sometimes referred to as Advanced Thermal Technologies or Alternative Conversion Technologies. Pyrolysis and gasification typically rely on carbon-based waste such as paper, petroleum-based wastes like plastics, and organic materials such as food scraps or another biomass. In some embodiments, biomass is broken down to create gas, solid and liquid residues. In some embodiments, the gas products can be combusted in a secondary process. A pyrolysis process thermally degrades waste in the absence of oxygen and/or air. A Gasification process exposes materials to some amount of oxygen, but not enough to allow combustion to occur. In some embodiments, temperatures may be maintained above 700° C. In some embodiments, the pyrolysis phase is followed by one or more additional gasification stages, which remove additional energy carrying gases are liberated from the input. In some embodiments, the main product of gasification and pyrolysis is syngas, which is composed mainly of carbon monoxide and hydrogen, with smaller quantities of carbon dioxide, nitrogen, methane and various other hydrocarbon gases.

In some embodiments, gasification and pyrolysis used herein may involve separate steps comprising preparation of a feedstock, heating the feedstock, and separating the products. In some embodiments, the feedstock may comprise biomass or be in the form of a refuse derived fuel, produced by a Mechanical Biological Treatment plant or an autoclave. Alternatively, the feedstock may comprise waste processed through a materials recycling process, to remove some recyclables and materials that have no calorific value (e.g., grit). In some embodiments, heating the feedstock in a low-oxygen atmosphere produces a gas, oil, and sustainable carbon product. The sustainable carbon product byproduct may be used to supplement feedstock according to various embodiments herein.

In some embodiments, biomass gasification is a process that converts biomass at high temperatures (>700° C.), with a controlled amount of oxygen and/or steam into carbon monoxide, hydrogen, and carbon dioxide. The carbon monoxide then reacts with water to form carbon dioxide and more hydrogen via a water-gas shift reaction. Adsorbers or special membranes can separate the hydrogen from this gas stream. A simplified biomass gasification reaction may comprise: C₆H₁₂O₆+O₂+H₂O→CO+CO₂+H₂+other species (e.g., carbon residue or sustainable carbon product).

As used herein, Pyrolysis is the gasification of biomass in the absence of oxygen. In general, biomass does not gasify as easily as coal, and it produces other hydrocarbon compounds in the gas mixture exiting the gasifier; this is especially true when no oxygen is used. As a result, typically an extra step must be taken to reform these hydrocarbons with a catalyst to yield a clean syngas mixture of hydrogen, carbon monoxide, and carbon dioxide. Then, just as in the gasification process for hydrogen production, a shift reaction step (with steam) converts the carbon monoxide to carbon dioxide. The hydrogen produced can then be separated and purified. A simplified water-gas shift reaction may comprise: CO+H₂O→CO₂+H₂+heat.

While syngas, a mixture of CO, H₂, and other hydrocarbons, is considered to be the main product of the biomass gasification process and is used in electricity generation, a byproduct of the biomass gasification process is a carbon residue or sustainable carbon product, a precursor to activated carbon. This carbon residue or sustainable carbon product is created when the biomass feedstock decomposes, lowers its density, and increases its porosity during gasification.

Utilization of sustainable carbon product produced by the above gasification processes may provide the benefit of decreased methane generation. For example, in some embodiments, methane production may be reduced by around 25% relative to other carbon product generation processes. Additionally, carbon credits or other tradeable certificates or permits may be obtained as a result of the reduced carbon dioxide generation associated with gasification processes.

Sustainable carbon product described herein may be complexed with, e.g., kaolin clay (bolus 149 alba), propylene glycol, and various wetting and dispersing agents. Among the wetting agents and dispersants may be naphthalene sulfonates, alkyl aryl polymers, and triethanolamine, among others. Alternative formulations may use other clays and mined minerals such as bentonite and gypsum, synthetically treated minerals such as dicalcium phosphate and silica gels, vegetable gums, synthetic vegetable derivatives such as sodium carboxymethylcellulose, solvents such as isopropanol, and synthetic suspension polymers such as povidone.

In addition, in some embodiments, the sustainable carbon product may be supplemented with one or more additional ingredients for use as an animal feed supplement. For example, in some embodiments, a sustainable carbon gel formulation may comprise about 75% bentonite, about 25% fine sustainable carbon product, and additional additives comprising probiotics, xanthum gum, potassium sorbate, and/or sterile water.

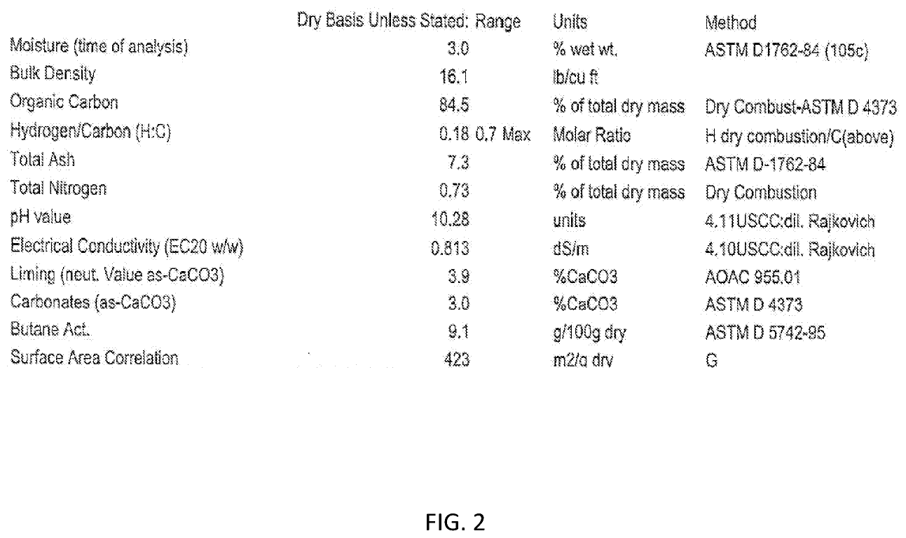

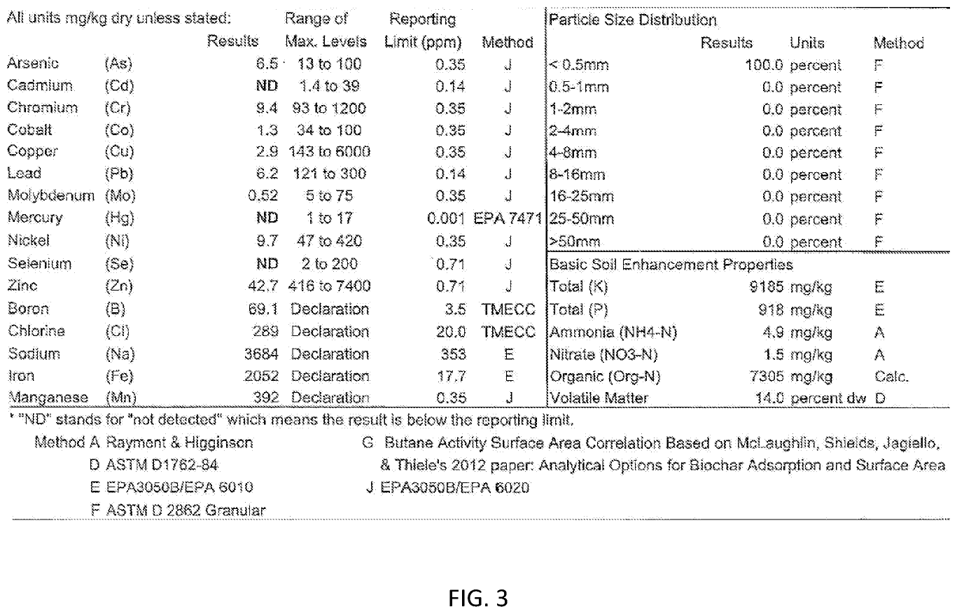

FIG. 2 illustrates a table of various properties of an example sustainable carbon product according to some embodiments herein. FIG. 3 illustrates a table of compositional and physical properties of an example sustainable carbon product according to some embodiments herein.

### EXAMPLES

### Example 1

After inoculation of a ligated ileal loop with different pathogens, samples were analyzed for microbial invasion, and histologic and ultrastructural morphologic changes were observed. The loops were also inoculated with carbon (e.g., Sustainable carbon product), montmorillonite clay, a mixture of both, and a common aminoglycoside, neomycin. Each loop had a separate treatment administered as well as a pathogen (E. coli, Salmonella, and mycotoxin). Carbon performed well against the microbial pathogens, resulting in a 2 log kill or 3-log kill. A 2-log kill destroys 99% of the microbes, while a 3-log kill results in a 99.9% reduction of the microbes.

### Example 2

The experimental materials comprised 800 Cobb 500 broiler chickens. One-day-old chickens of both sexes were randomly allocated to two feeding groups, each with four replicates of 100 birds. The chickens were reared for six weeks on deep litter and were fed standard pelleted diets in a three-stage system (starter, grower, and finisher). Control group (I) birds received basal diets and experimental group (II) birds received identical diets supplemented with sustainable carbon product (charcoal) in the amount of 0.3%. Sustainable carbon product was added to diets at the feed mill. Dietary supplementation with sustainable carbon product was found to have a beneficial effect on the performance results of broilers. At the completion of a six-week rearing period, the body weights of chickens in the experimental group (fed sustainable carbon product-supplemented diets) increased significantly by 3.5% and their feed conversion ratio improved by 2.0%, compared with the control group.

Charcoal obtained through dry distillation of hardwood contains approximately 96% of pure carbon and 4% of other mineral compounds in organic form. Insoluble mineral compounds contained in charcoal undergo dissociation in the presence of gastric hydrochloric acid. They are converted into colloidal, soluble, and active form. Ions of elements act as biocatalysts. Therefore, they contribute to regulating metabolic processes, maintaining the proper osmotic potential of body fluids, activating enzymes, hormones, and antibodies. Charcoal has adsorptive properties. It acts curatively on the gastrointestinal tract, adsorbing gases such as hydrogen and ammonia that are formed there, bacterial toxins as well as mycotoxins produced by fungi. Charcoal is also beneficial in cases of poisoning by such compounds as alkaloids, phenol, glycosides and even strychnine and potassium cyanide. Charcoal is not digested in the gastrointestinal tract, and it binds various substances through physical interactions regardless of whether they are ionized or not. By binding of ammonia, charcoal protects the intestines against alkalization. It prevents intestinal infections and stops diarrhea by adsorbing and eliminating the germs in feces, but it is not bactericidal. The minerals contained in charcoal form bases with water, lower the surface tension of the digesta and emulsify fat, thereby supporting liver functions and enabling the digestion and assimilation of fat. Charcoal's favorable influence on increasing the body weight of broiler chickens, their survival and feed utilization has been described. The aim of this study was to determine the effect of hardwood charcoal on the performance of broiler chickens.

The experiment was conducted on 800 Cobb 500 chickens. One-day-old chickens of both sexes were randomly allocated to two feeding groups, each with four replicates of 100 birds. The chickens were reared for six weeks on deep litter and were fed standard pelleted diets in a three-stage system (starter, grower, and finisher). Control group (I) birds received basal diets and experimental group (II) birds received.

Identical diets supplemented with charcoal in the amount of 0.3% (3 kg per ton). Charcoal was added to diets at the feed mill. The nutritional value of diets is presented in Table 1. All birds were weighed individually on day 21 and 42 of age. Feed consumption was determined weekly and mortality rates were recorded daily. At the end of the experiment, 16 males of each group with body weights close to the average value of the group were slaughtered and dissected. The results were verified statistically by an analysis of variance and Duncan's test, with the use of Statistica for Windows software (StatSoft Inc. 2009). The experimental results were processed statistically using Statistica for Windows software (StatSoft Inc. 2009). Data in tables are given as means±standard deviation.

Charcoal had a beneficial effect on the growth performance of boilers (Table 2). At 21 days of age, experimental group (II) birds receiving diets with 0.3% of charcoal were by around 5% (39 g) heavier than the control group (I) birds (statistically significant difference). After 42 days, experimental group birds were significantly (89 g, i.e., 3.5%, p<0.01) heavier than control group birds. The addition of charcoal favorably affected the feed conversion ratio (Table 2). Chickens fed charcoal coal-supplemented diets consumed on average around 2% less feed per kilogram of body weight than control group birds.

The mortality rate of birds was similar in both groups, reaching 3.7% in the control group and 3.1% in the experimental group. The addition of charcoal to diets had no significant effect on carcass dressing percentage and the proportion of muscles in body weight (Table 3).

TABLE 1
Calculated Energy and Nutrient Content of Diets

| | Starter | Grower | Finisher |
|---|---|---|---|
| Specification | 0-14 Days | 15-35 Days | 36-42 Days |
| ME, kcal | 2954 | 3020 | 3150 |
| Crude Protein, g | 215.2 | 194.9 | 178.3 |
| Crude Fiber, g | 33.5 | 31.9 | 31.2 |
| Available P, g | 5.03 | 4.59 | 4.21 |
| Natrium, g | 1.73 | 1.68 | 1.42 |
| Lysine, g | 12.11 | 11.07 | 10.35 |
| Methionine, g | 5.21 | 4.76 | 4.39 |
| Coccidiostat | Clinacox | Clinacox | — |

TABLE 2
Growth Performance of Broilers

| | Groups | | | | |
|---|---|---|---|---|---|
| | | II - Experimental | Relative Value | | |
| Specification | I - Control | (Charcoal) | (Control = 100) | SEM | P |
| Body Weight, kg | | | | | |
| 21 Days | 0.801^{b} ± 0.012 | 0.839^{a} ± 0.013 | 104.7 | 0.008 | 0.005 |
| 42 Days | 2.561^{b} ± 0.040 | 2.650^{a} ± 0.025 | 103.5 | 0.020 | 0.009 |
| Feed Conversion | 1.983 ± 0.038 | 1.944 ± 0.028 | 98.0 | 0.014 | 0.102 |
| Ratio, kg/kg weight | | | | | |
| gain (1-42 days) | | | | | |
| Mortality, % | 3.7 | 3.1 | | | |
| (1-42 days) | | | | | |

^{a,b}Values followed by superscript letter are significantly different;
^{a,b}P ≤ 0.05

TABLE 3
Slaughter Analysis (%) of Broilers (body weight - 100%)

| | Groups | | | |
|---|---|---|---|---|
| | | II - Experimental | | |
| Specification | I - Control | (Charcoal) | SEM | P |
| Dressing Percentage | 76.09 ± 0.65 | 76.38 ± 0.85 | 0.138 | 0.311 |
| Breast Muscles | 15.75 ± 0.56 | 16.28 ± 0.87 | 0.140 | 0.060 |
| Thigh Muscles | 9.08 ± 0.44 | 9.31 ± 0.29 | 0.070 | 0.096 |
| Drumstick Muscles | 7.21 ± 0.31 | 7.25 ± 0.55 | 0.080 | 0.824 |
| Heart | 0.41 ± 0.04 | 0.39 ± 0.03 | 0.006 | 0.247 |
| Liver | 1.63 ± 0.11 | 1.65 ± 0.12 | 0.021 | 0.606 |
| Gizzard | 0.97 ± 0.10 | 0.98 ± 0.12 | 0.021 | 0.774 |

The final body weight of broilers was approximately 5.32% (127 g) higher and the FCR was around 0.50% (11 g) lower. The mortality rates in the control group reached 4.00%, while in the experimental group no cases of death were recorded. Edrington et al. (1997) fed super activated charcoal (SAC) to broilers and reported a 4.4% increase in their body weight gain after 21 days. Shareef et al. (1998) who added SAC in the amount of 0.5% to broiler diets reported an increase in the body weights of birds (approx. 4.6%) and lower mortality rates, in comparison with the control group after 3 weeks. In another experiment (Majewska et al., 2002), after an 18-week rearing period, turkeys receiving charcoal supplementation in the amount of 0.3% were by 5.9% (0.850 g on average) heavier and their feed conversion ratio was by 6.5% lower, compared with the control group. The livability of birds receiving supplemental charcoal was very good (99.02%), while in the control group mortality rates reached 12.7%. In an experiment by Kutlu et al. (1999), the body weight of broilers fed by charcoal-supplemented diets increased by 5.9% and 7.8% at 3 and 6 weeks of age, respectively. The cited authors reported a better dressing percentage (by 0.3%) in the experimental group.

The authors attributed the above results to the presence of available microelements and to the detoxicating effect of charcoal, lowering the surface tension of the intestinal digesta and supporting liver function with respect to fat digestion. Research findings suggest that the beneficial influence of charcoal is higher in poor-quality diets.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example process in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method of preventing or treating microbial infection in an animal by incorporating sustainable carbon product into an animal feed, the method comprising:
obtaining the sustainable carbon product from a process comprising:
obtaining a biomass feedstock;
feeding the biomass feedstock to a gasification or pyrolysis system;
gasifying or pyrolyzing the biomass feedstock in the gasification or pyrolysis system to produce a gas and the sustainable carbon product; and
incorporating a predetermined amount of the sustainable carbon product per day per animal into an animal feed of an animal subject in need thereof

2. The method of claim 1, wherein incorporating the predetermined amount of the sustainable carbon product per day per animal into the animal feed results in at least a 90% reduction in microbe forming the microbial infection.

3. The method of claim 2, wherein the incorporating the predetermined amount of the sustainable carbon product per day per animal into the animal feed results in at least a 99% reduction in microbe forming the microbial infection.

4. The method of claim 3, wherein the incorporating the predetermined amount of the sustainable carbon product per day per animal into the animal feed results in at least a 99.9% reduction in microbe forming the microbial infection.

5. The method of claim 2, wherein the microbe comprises E. coli, Salmonella, aflatoxin, Campylobacter, or mycotoxin.

6. The method of claim 1, wherein the sustainable carbon product comprises particles having a size range of less than 325 mesh.

7. The method of claim 1, wherein the biomass comprises agriculture crop residues, forest residues, special crops grown specifically for energy use, organic municipal solid waste, or animal waste.

8. The method of claim 1, wherein the biomass comprises at least one of pine wood, almond shells and hulls, pistachio shells, and walnut shells.

9. The method of claim 1, wherein the sustainable carbon product comprises at least 85% carbon.

10. The method of claim 1, wherein the sustainable carbon product comprises hydrogen, nitrogen, sulfur, or oxygen.

11. The method of claim 1, wherein the sustainable carbon product comprises less than 10% ash.

12. The method of claim 1, wherein the sustainable carbon product comprises less than 10% water.

13. The method of claim 1, wherein the sustainable carbon product comprises substantially no heavy metals or pesticides.

14. The method of claim 1, wherein a moisture content of the sustainable carbon product is less than 5%.

15. The method of claim 1, wherein the sustainable carbon product has a bulk density of about 0.42 g/cm³ uncompacted.

16. The method of claim 1, wherein the sustainable carbon product has a pH ranging from 6 to 10.

17. The method of claim 1, wherein the sustainable carbon product has a melting point of about 3500° C.

18. The method of claim 1, wherein the process comprises a chemical reaction comprising: C₆H₁₂O₆+O₂+H₂O→CO+CO₂+H₂+sustainable carbon product.

19. The method of claim 1, further comprising incorporating a predetermined amount of montmorillonite clay, a mixture of sustainable carbon product and montmorillonite clay, or neomycin per day per animal into the animal feed.

20. The method of claim 1, wherein the sustainable carbon product binds with at least one of ammonia or hydrogen gas in an intestinal tract of the animal.
